(19) United States
(12) Patent Application Publication
(10) Pub. No.: US 2004/0007276 A1
(43) Pub. Date: Jan. 15, 2004

(54) Beer delivery apparatus

(76) Inventor: John Sugg, Austin, TX (US)

Correspondence Address: Patrick Stellitano, 2803 Inridge Dr., Austin, TX, 78745, US

(21) Appl. No.: 10/192,939

(22) Filed: Jul. 11, 2002

(51) Int. Cl. F16K 11/22

(52) U.S. Cl. 137/883

(57) ABSTRACT

The present invention provides apparatus and methods for distributing beer from a keg to a plurality of destinations. Beer is received from the keg through a coupler and divided to a plurality of branches that may be opened with by valves.

### TECHNICAL FIELD OF THE INVENTION

The present invention relates to the field of distributing beer from a beer keg.

### BACKGROUND OF THE INVENTION

Beer kegs are a familiar sight to many people, especially in industrialized nations. Among young adults, and college students in particular, the beer keg is often the preferred container for providing beer at parties. This is true for several reasons. First, a beer keg holds a lot of beer. Second, the keg is easy to chill. Third, it eliminates the unwanted side effect of having lots of empty cans lying around in the aftermath of an all-nighter.

A typical beer keg comprises an aluminum cylindrical vessel with a long cylindrical tube in its interior mounted down the center close to a side. The tube extends from near the bottom of the keg to the top. At the top is a fitting that enables a device called a coupler to connect to the tube. Attached to the coupler is a hand pump with a handle. When the handle is pumped air is forced down into the tube. The air escapes from the bottom of the tube and rises through the beer to the top. This displaces an amount of liquid, forcing liquid up through the tube and out a spigot on a hose attached to the coupler. One end of that hose is attached to the spigot. A reveler may then fill his or her glass with beer by holding the other end of the hose in the glass and pumping the handle. Alternatively, the hose may be equipped with a valve that must be opened to enable beer to flow out of the hose into the glass. In this configuration, the keg may be pumped to a certain amount of pressure periodically, and beer may be dispensed without pumping the keg each time a glass is to be filled.

A major problem almost always arises when a plurality of people desire to obtain a refill of their glass at about the same time. A crowd tends to form around the keg, each person waiting for his turn to obtain a refill. This can lead to undesirably long delays, and increased agitation among participants. Those who drink beer faster than others will tend to hang around the keg, whereas those who desire a refill less often will notice that certain people seem to be crowding them out. Thus, not being able to simultaneously distribute beer from a keg to a plurality of people can give rise to feelings of resentment and dissatisfaction, thereby detracting from the overall festive mood. There is an important need, therefore, to increase the number of people that can simultaneously be served from a keg.

### SUMMARY OF THE INVENTION

The present invention overcomes prior art limitations by providing apparatus and methods for simultaneous delivery of beer from a keg to a plurality of recipients or to a plurality of destinations. According to the present invention a divider is provided for receiving beer from a coupler in one branch and delivering the received beer to a plurality of destination points. Valves in a flow path between a destination point and the divider for enabling and disabling the flow of beer to the destination points are also provided.

The foregoing has outlined rather broadly the features and technical advantages of the present invention in order that the detailed description of the invention that follows may be better understood. Additional features and advantages of the invention will be described hereinafter. It should be appreciated by those skilled in the art that the disclosure provided herein may be readily utilized as a basis for modifying or designing other structures for carrying out the same purposes of the present invention. Persons of skill in the art will realize that such equivalent constructions do not depart from the spirit and scope of the invention as set forth in the appended claims, and that not all objects attainable by the present invention need be attained in each and every embodiment that falls within the scope of the appended claims.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows an embodiment of the present invention.

FIG. 2 shows an embodiment of the present invention.

### DETAILED DESCRIPTION OF THE PREFERRED EMBODIMENTS

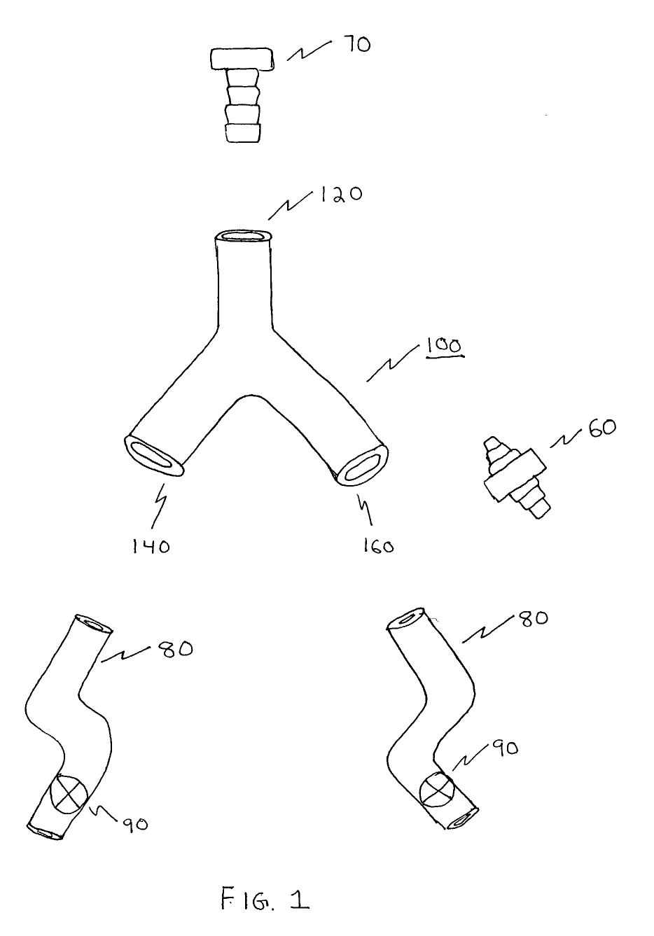

A preferred embodiment of the present invention is shown in FIG. 1. A divider apparatus 100 is provided comprising an input branch 120 and a plurality of output branches 140 and 160. Apparatus 100 functions to cause the flow of beer received by input branch 120 into the branches 140 and 160. The branch 120 receives beer by coupling branch 120 to the output section 70 of a standard commercially available coupler (not shown) that is connected to a beer keg.

Divider 100 may be formed of suitable material such as stainless steel or a sturdy but flexible rubber or plastic material. If made of steel or other rigid metal, divider 100 may be welded to output section 70 of a coupler or bonded or cast as a unitary piece with the nipple of a coupler. Alternatively, divider 100 may be removably connected to output section 70 by a flexible hose of a desired length. One end of the hose would be removably connected to branch 120 and the other end of the hose would be removably connected to output section 70. If divider 100 is made of a sturdy but flexible rubber or plastic, it may be irremovably connected directly to output section 70 by, for example, an adhesive compound, or removably connected directly to output section 70.

FIG. 1 also shows hoses 80 that may be connected one to each branch 140 and 160 of divider 100. Each hose 80 comprises a valve 90, shown schematically, which may be opened to allow beer to flow there through, or closed when not dispensing beer. Preferably, hose 80 is of a flexible rubber or plastic material of a desired length. This enables two different users to separately and simultaneously dispense beer into a container. Each hose may be irremovably attached to a branch 140 or 160 or removably attached there to. A dual nipple connector 60 may be used to removably attach hose 80 to a branch 140 or 160. Further each hose 80 is sufficiently long to allow the beer to be dispensed at locations that are amply spaced apart to avoid crowding.

Different coupling devices may provide different configurations and sizes of output section 70. As shown in FIG. 1, output section 70 is a typical ridged nipple which readily and removably inserts into a flexible hose. Other types of output sections, including those that comprise clamping mechanisms are known in the art. In one embodiment of the invention, branch 120 is manufactured to be connected to a particular type of output section 70 of a particular model of coupler. In an alternative embodiment of the invention, an adapter may be provided separately, with one end having a configuration that is mate-able to the simple tube structure of branch 120 shown in FIG. 1, and with the other end of the adapter configured to mate to a particular type of output section 70 of a particular model of coupler.

In a typical transaction, a consumer will purchase the beer that is in the keg and will rent the keg and equipment for dispensing beer from the keg. The keg and dispensing equipment is then returned upon consumption of the keg's contents. The apparatus of the present invention for distributing beer to a plurality of different points simultaneously can be provided as part of the equipment that may be rented to dispense the beer. The divider 100 and hoses 80 with valves 90 and connector 60 may be provided as individual parts to be assembled by the consumer or provided as a pre-assembled unit. Further, the pre-assembled unit can be pre-attached to the coupler by way of output section 70, so that the consumer obtains the entire coupler, divider, and hoses assembled as a unit.

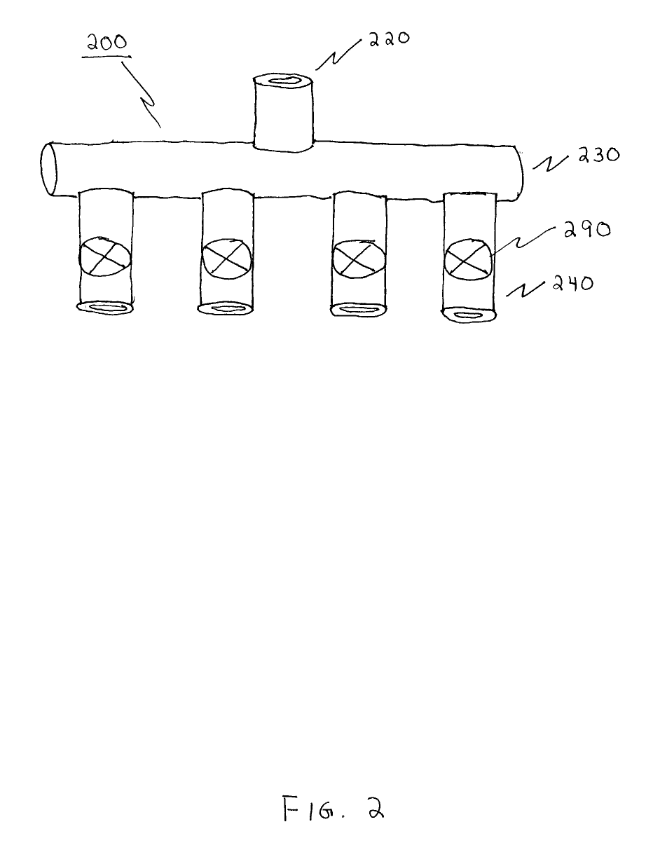

Another embodiment of the present invention is shown in FIG. 2 as divider 200. Input branch 220 is removably, or alternatively, irremovably mate-able to an output section of a coupler (not shown). Input branch 220 communicates with transition section 230, which is in communication with a plurality of output branches 240. Beer received from the coupler flows into branch 220 and is communicated by section 230 to each of the plurality of output branches 240. Each output branch 240 contains a valve 290, shown schematically, that can be opened to allow beer to flow out of the branch, or closed to prevent beer from being dispensed from that branch.

Divider 200 can be made of sections of stainless steel tube. Branch 220 and branches 240 can be welded, bonded, or otherwise formed as a unitary piece with section 230. Alternatively, holes can be drilled into section 230 and threaded to mate with threaded ends of branches 220 and 240. Then, the configuration can be provided in a disassembled state, to be assembled by the end user. In the event there are less branches 240 than holes in section 230, the excess holes may be plugged with a threaded cap. Note that hoses 80, as shown in FIG. 1, can be connected to branches 240 shown in FIG. 2. As an alternative to providing branches 240 with valves 290, therefore, branches 240 without valves 290 can be provided and used in conjunction with hoses 80 with valves 90.

Thus, the present invention provides an apparatus for distributing beer from a keg to many different points simultaneously. Although the present invention and its advantages have been described in detail, it should be understood that various changes, substitutions and alterations can be made herein without departing from the spirit and scope of the invention as defined by the appended claims. The invention achieves multiple objectives and because the invention can be used in different applications for different purposes, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A divider apparatus for distributing beer from a keg to a plurality of destinations, comprising:
a receiving branch for receiving beer from the keg; and
a plurality of output branches for delivering the received beer to a plurality of destination points.

2. The apparatus of claim 1, further comprising a flow path from an output branch to a destination point.

3. The apparatus of claim 2, wherein the flow path comprises a valve for enabling and disabling a flow of beer through the flow path to the destination point.

4. The apparatus of claim 3, further comprising a valve in an output branch.

5. The apparatus of claim 1, further comprising a valve in an output branch.

6. The apparatus of claim 1, further comprising a coupler connected to the keg.

7. The apparatus of claim 6, further comprising a connecting section between said coupler and the receiving branch.

8. The apparatus of claim 7, further comprising a flow path from an output branch to a destination point.

9. The apparatus of claim 8, wherein the flow path comprises a valve for enabling and disabling a flow of beer through the flow path to the destination point.

10. The apparatus of claim 1, further comprising a connecting section for coupling the receiving section to a coupler connectable to the keg.

11. The apparatus of claim 10, further comprising a flow path from an output branch to a destination point.

12. The apparatus of claim 11, wherein the flow path comprises a valve for enabling and disabling a flow of beer through the flow path to the destination point.

13. The apparatus of claim 1, wherein the receiving branch is removably connected to a transition section of the divider.

14. The apparatus of claim 13, further comprising a flow path from an output branch to a destination point.

15. The apparatus of claim 14, wherein the flow path comprises a valve for enabling and disabling a flow of beer through the flow path to the destination point.

16. The apparatus of claim 13, wherein an output branch is removably connected to the transition section.

17. The apparatus of claim 14, wherein an output branch is removably connected to a transition section of the divider.

18. The apparatus of claim 1, wherein an output branch is removably connected to a transisiton section of the divider.

19. The apparatus of claim 18, further comprising a flow path from an output branch to a destination point.

20. The apparatus of claim 19, wherein the flow path comprises a valve for enabling and disabling a flow of beer through the flow path to the destination point.
